(19) United States
(12) Patent Application Publication
(10) Pub. No.: US 2024/0094015 A1
(43) Pub. Date: Mar. 21, 2024

(54) ROUTE GENERATION SYSTEM, ROUTE GENERATION METHOD, AND RECORDING MEDIUM

(71) Applicant: NEC Corporation, Tokyo (JP)

(72) Inventors: Yusuke Mizukoshi, Tokyo (JP); Chisato Sugawara, Tokyo (JP); Yoshihiro Nishikawa, Tokyo (JP); Yuta Shimizu, Tokyo (JP)

(73) Assignee: NEC Corporation, Tokyo (JP)

(21) Appl. No.: 18/122,406

(22) Filed: Mar. 16, 2023

(30) Foreign Application Priority Data
Sep. 20, 2022 (JP) 2022-148862

(51) Int. Cl. G01C 21/34; G01C 21/36

(52) U.S. Cl. CPC G01C 21/3461; G01C 21/3602; G01C 21/3647; G01C 21/3694

(57) ABSTRACT

A route generation system includes a diagnosis unit, a generation unit, and an output unit. The diagnosis unit performs a diagnosis to estimate a deterioration degree of a road surface from an image to be monitored. The generation unit generates a travel route based on the deterioration degree of the road surface for each point diagnosed by the diagnosis unit and information regarding a road environment affecting the diagnosis for each point, the travel route being generated for capturing another image used for another diagnosis. The output unit outputs the generated travel route.

This application is based upon and claims the benefit of priority from Japanese Patent Application No. 2022-148862, filed on Sep. 20, 2022, the disclosure of which is incorporated herein in its entirety by reference.

### TECHNICAL FIELD

The present disclosure relates to a route generation system and the like.

### BACKGROUND ART

A road manager monitors a road surface condition at each point of a management target road, for example, by traveling on the management target road by the vehicle. Then, the road manager determines the necessity of repair of the road based on, for example, the monitoring result of the road surface condition of the road. A lot of work time is possibly required to go around the management target road and monitor each point. Therefore, a technique for efficiently monitoring the road surface condition of the road has also been developed.

The deterioration diagnosis system of JP 2022-14432 A diagnoses deterioration of a road by using an image of the road captured by using an image-capturing device mounted on a vehicle and information detected by a sensor mounted on the vehicle.

### SUMMARY

An example of an object of the present disclosure is to provide a route generation system and the like that can improve efficiency of monitoring of a road surface condition of a road performed by traveling of a vehicle.

A travel route generation system in one aspect of the present disclosure includes: a diagnosis unit configured to perform a diagnose to estimate a deterioration degree of a road surface from an image of a road to be monitored; a generation unit configured to generate a travel route based on the deterioration degree of the road surface for each point diagnosed by the diagnosis unit and information regarding a road environment affecting the diagnosis for each point, the travel route being generated for capturing another image used for another diagnosis; and an output unit configured to output the generated travel route.

A travel route generation method in one aspect of the present disclosure includes: performing a diagnosis to estimate a deterioration degree of a road surface from an image of a road to be monitored generating a travel route based on the deterioration degree of the road surface for each point diagnosed and information regarding a road environment affecting the diagnosis for each point, the travel route being generated for capturing another image used for another diagnosis; and outputting the generated travel route.

A non-transitory recording medium in one aspect of the present disclosure records a travel route generation program that causes a computer to execute processing of performing a diagnosis to estimate a deterioration degree of a road surface from an image of a road to be monitored, processing of generating a travel route based on the deterioration degree of the road surface for each point diagnosed and information regarding a road environment affecting the diagnosis of the deterioration degree for each point, the travel route being generated for capturing another image used for another diagnosis, and processing of outputting the generated travel route.

### BRIEF DESCRIPTION OF THE DRAWINGS

Exemplary features and advantages of the present disclosure will become apparent from the following detailed description when taken with the accompanying drawings in which:

FIG. 1 is a view illustrating an example of a configuration in an example embodiment of the present disclosure;

FIG. 2 is a view schematically illustrating an example of monitoring a road surface condition of a road by traveling of a vehicle;

FIG. 3 is a view illustrating an example of a configuration of a route generation system in the example embodiment of the present disclosure;

FIG. 4 is a view illustrating an example of a display screen in the example embodiment of the present disclosure;

FIG. 5 is a view illustrating an example of a display screen in the example embodiment of the present disclosure;

FIG. 6 is a view illustrating an example of a display screen in the example embodiment of the present disclosure;

FIG. 7 is a view illustrating an example of a display screen in the example embodiment of the present disclosure;

FIG. 8 is a view illustrating an example of a display screen in the example embodiment of the present disclosure;

FIG. 9 is a view illustrating an example of an operation flow of the route generation system in the example embodiment of the present disclosure; and

FIG. 10 is a view illustrating an example of another configuration of the present disclosure.

### EXAMPLE EMBODIMENT

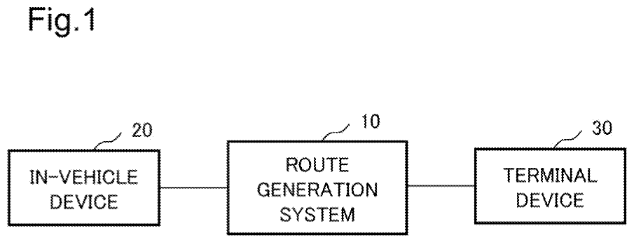

An example embodiment of the present invention will be described in detail with reference to the drawings. FIG. 1 is a view illustrating an example of the configuration of a road management system. The road management system includes a route generation system 10, an in-vehicle device 20, and a terminal device 30. The route generation system 10 is connected to the in-vehicle device 20 via a network. The route generation system 10 is connected to the terminal device 30 via a network. A plurality of in-vehicle devices 20 and a plurality of terminal devices 30 may be provided.

The route generation system 10 is a system that generates a travel route of a vehicle used for monitoring a road surface condition of a road. The travel route is, for example, a route in which a road manager causes a vehicle to travel for the purpose of monitoring the road surface condition of the road. The vehicle used for monitoring the road surface condition of the road acquires an image used for diagnosis of deterioration of the road, for example, by capturing an image of the road using a mounted image-capturing device.

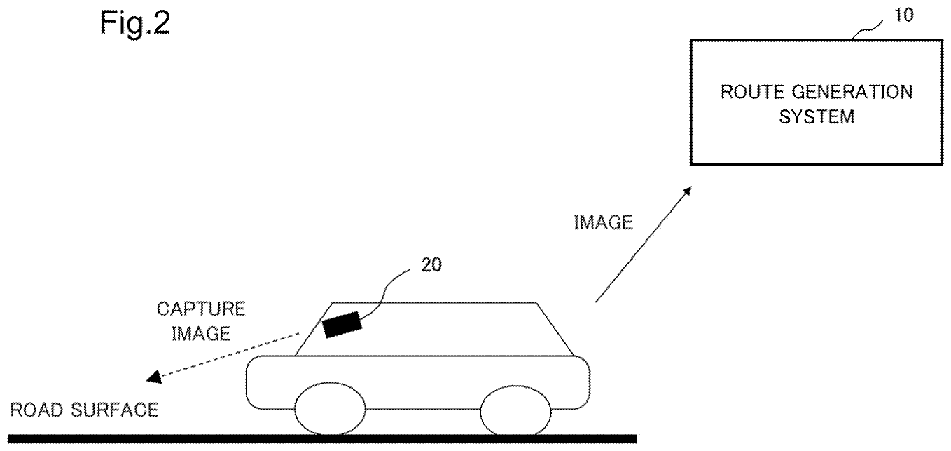

FIG. 2 is a view schematically illustrating an example of monitoring the road surface condition of the road performed by traveling of the vehicle. In the example of FIG. 2, the in-vehicle device 20 is mounted on the vehicle. The in-vehicle device 20 captures an image a road surface while traveling on the road by, for example, the image-capturing device. Then, the in-vehicle device 20 outputs the captured image to the route generation system 10, for example. Deterioration diagnosis of the road surface of the road may be performed by a system outside the route generation system 10. When the deterioration diagnosis of the road surface of the road is performed by an external system, the in-vehicle device 20 outputs a captured image to a system that performs the deterioration diagnosis of the road surface of the road based on the image of the road, for example.

The in-vehicle device 20 may include a sensor that measures the travel state of the vehicle. The in-vehicle device 20 includes, for example, an acceleration sensor that measures vibration in the up-down direction of the vehicle. The in-vehicle device 20 may include an acceleration sensor that measures acceleration in the travel direction of the vehicle. The sensor that measures the travel state of the vehicle is not limited to the above. When the in-vehicle device 20 includes the sensor, for example, the in-vehicle device 20 outputs data measured by the sensor to the route generation system 10.

The route generation system 10 diagnoses the deterioration degree of the road surface at the capturing point from, for example, an image in which the road surface of the road appears. The image in which the road surface of the road appears is captured by the in-vehicle device 20 mounted on the vehicle traveling on the road. The in-vehicle device 20 captures an image of the road when the vehicle is traveling on the monitoring target road. The in-vehicle device 20 captures an image of the road in such a way that the road surface appears. For example, a dashboard camera is used as the in-vehicle device 20. The in-vehicle device 20 may be other than a dashboard camera.

The route generation system 10 generates a travel route for capturing an image used for diagnosis of the deterioration degree of the road surface based on the deterioration degree of the road surface and information regarding a road environment affecting diagnosis of the deterioration degree of the road surface for each point. The travel route is, for example, a route on which a vehicle mounted with the image-capturing device that captures an image used for diagnosis of the deterioration degree of the road surface travels. The road environment that affects diagnosis of the deterioration degree of the road surface for each point is, for example, a road environment where it becomes difficult to determine the state of the road surface appearing in the image. The road environment that affects diagnosis of the deterioration degree of the road surface for each point is, for example, a road environment that makes it difficult to recognize the deterioration state of the road surface of the road at the time of image recognition.

The road environment where it becomes difficult to determine the state of the road surface appearing in the image refers to, for example, a road environment where the contrast ratio of the image obtained by capturing the road is low and it is difficult to recognize the state of the road surface appearing in the image. The contrast ratio of the image obtained by capturing the road decreases due to, for example, a shadow cast on the road. When the contrast ratio of the image obtained by capturing the road is low and the contrast ratio of the image is raised by image processing, blocked-up shadows or blown-out highlights occur in the image, and it becomes difficult to recognize the state of the road surface appearing in the image. In a case where the sun is behind with respect to the capturing direction of the image-capturing device, the contrast ratio of the image obtained by capturing the road can decrease. Therefore, when the sun is behind with respect to the capturing direction of the image-capturing device, the captured image can be crushed. The state in which the sun is behind with respect to the capturing direction of the image-capturing device is a state in which the sunlight is irradiated from the back side with respect to the capturing direction. The state in which the sun is behind with respect to the capturing direction of the image-capturing device is also called front light.

The road environment where it becomes difficult to determine the state of the road surface appearing in the image may be, for example, a road environment where the road surface is hidden by the presence of other vehicles. The road environment where the road surface is hidden by the presence of other vehicles can occur, for example, due to traffic congestion of the road. The road environment where the road surface is hidden by the presence of other vehicles can occur, for example, on a road with a large traffic volume.

The road environment where it becomes difficult to determine the state of the road surface appearing in the image may be, for example, a road environment where the road surface is hidden due to a factor other than the vehicle. The road environment where the road surface is hidden due to a factor other than the vehicle can occur, for example, due to the presence of fallen leaves, fallen branches, snow cover, rainwater, earth and sand, or volcanic ash on the road surface. The road environment where the road surface is hidden to make it difficult to determine the state of the road surface appearing in the image is not limited to the above.

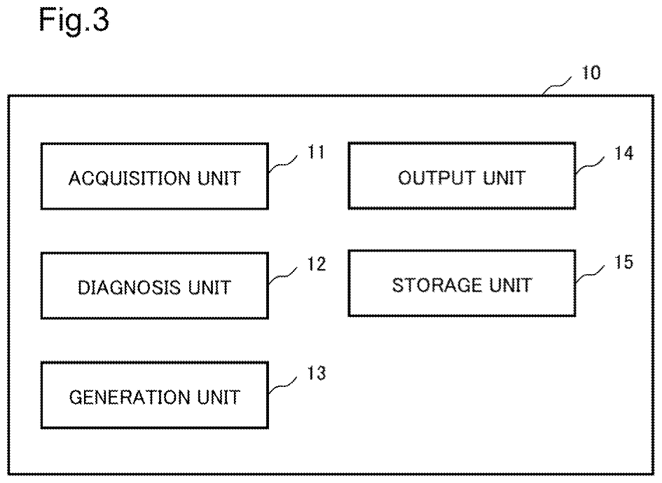

Here, the configuration of the route generation system 10 will be described. FIG. 3 is a view illustrating an example of the configuration of the route generation system 10 in the example embodiment of the present invention.

The route generation system 10 includes a diagnosis unit 12, a generation unit 13, and an output unit 14 as basic configurations. The route generation system 10 includes, for example, an acquisition unit 11 and a storage unit 15.

The acquisition unit 11 acquires an image obtained by capturing the monitoring target road. The image obtained by capturing the road may be provided with, for example, information on the capturing point. The image obtained by capturing the road may be provided with, for example, information on the capturing date and time. The acquisition unit 11 acquires an image of a road captured by the in-vehicle device 20 from the in-vehicle device 20 mounted on the vehicle traveling on the road, for example. The acquisition unit 11 may acquire an image obtained by capturing the road from a camera installed on the road. The acquisition unit 11 may acquire an image obtained by capturing a road from a server connected via a network.

The acquisition unit 11 acquires information regarding a road environment that affects diagnosis of the deterioration degree of the road surface for each point, for example. The information regarding the road environment that affects diagnosis of the deterioration degree of the road surface is, for example, a time of day in which a shadow is cast on the road. The information regarding the road environment that affects diagnosis of the deterioration degree of the road surface for each point may be a range of the shadow cast on the road for each time of day. The shadow cast on the road is, for example, a shadow cast on the road by a building on the road, a building around the road, or a mountain forest. The information regarding the road environment that affects diagnosis of the deterioration degree of the road surface for each point may be the presence or absence of snow cover on the road. The information regarding the road environment that affects diagnosis of the deterioration degree of the road surface for each point may be the presence or absence of a puddle due to snow melting or spring water. The information regarding the road environment that affects diagnosis of the deterioration degree of the road surface for each point may be a time of day of front light with sun light received from behind the image-capturing device. The information regarding the road environment that affects diagnosis of the deterioration degree of the road surface for each point may be a congestion situation of the road. The information regarding the road environment that affects diagnosis of the deterioration degree of the road surface may be sunrise and sunset times. The information regarding the road environment that affects diagnosis of the deterioration degree of the road surface may be information regarding weather or weather prediction. The information regarding the road environment that affects diagnosis of the deterioration degree of the road surface is not limited to the above.

The road environment that affects diagnosis of the deterioration degree of the road surface for each point is input to, for example, the terminal device 30 by the operation of the worker. Then, the acquisition unit 11 acquires, from the terminal device 30, the road environment that affects diagnosis of the deterioration degree of the road surface for each point. The road environment that affects diagnosis of the deterioration degree of the road surface for each point may be input to the route generation system 10 by the operation of the worker. The acquisition unit 11 may acquire a road environment that affects diagnosis of the deterioration degree of the road surface from an information server connected via a network.

The acquisition unit 11 acquires information regarding generation of the travel route, for example. The information regarding generation of the travel route is, for example, a condition satisfied by the generated travel route. The condition satisfied by the generated travel route includes, for example, information regarding a point where it is determined whether the condition is satisfied. The acquisition unit 11 acquires, for example, a point where the deterioration degree is diagnosed. The acquisition unit 11 acquires a point through which the vehicle always passes in the travel route, for example. The point through which the vehicle always passes may be set by a criterion using the deterioration degree, for example. The point through which the vehicle always passes is set as, for example, a point where the deterioration degree is equal to or more than the criterion. The acquisition unit 11 may acquire a monitoring range. The monitoring range is a range for generating the travel route. The acquisition unit 11 may acquire map data used for generation of the travel route. The information regarding generation of the travel route is input to, for example, the terminal device 30 by the operation of the worker. Then, the terminal device 30 outputs information regarding the generation of the travel route to the route generation system 10.

The diagnosis unit 12 performs a diagnosis to estimate the deterioration degree of the road surface from an image obtained by capturing a monitoring target road. For example, the diagnosis unit 12 diagnoses the deterioration degree of the road surface appearing in the image in the image obtained by capturing the monitoring target road acquired by the acquisition unit 11. The diagnosis unit 12 may diagnose the deterioration degree of the road surface at the point set as a diagnosis target. The diagnosis unit 12 may continuously diagnose the deterioration degree regarding the road surface appearing in the image obtained by capturing the road. The point where the deterioration degree of the road surface is diagnosed is set by the worker, for example.

The diagnosis unit 12 diagnoses the deterioration degree of the road surface using, for example, a diagnosis model. For example, with an image in which the road surface of the road appears as an input, the diagnosis model diagnoses the deterioration degree of the road surface of the road appearing in the image. The diagnosis model is, for example, a learning model using an image recognition technology. The diagnosis model is generated by machine learning, for example. The diagnosis model is generated by deep learning using a neural network, for example. The diagnosis model is generated, for example, by learning the relation between the image in which the road surface appears and the deterioration degree. The diagnosis model is generated, for example, outside the route generation system 10.

The deterioration of the road surface is, for example, one or a plurality of a crack, a rut, a pothole, and a flatness abnormality occurring the road surface. The deterioration of the road surface is not limited to the above. When the deterioration of the road surface is a crack, the deterioration degree of the road surface is, for example, a crack rate. The crack rate is, for example, a value indicating a ratio between the area of deterioration included in an image captured at a certain point and the area of a road included in the image. When the deterioration of the road surface is a rut, the deterioration degree is, for example, a rut amount. When the deterioration of the road surface is the flatness abnormality, for example, the international roughness index (IRI) is used as the deterioration degree. The IRI is an index indicating flatness of the road. The IRI may be calculated based on the acceleration in the up-down direction of the vehicle. The measurement value of the acceleration in the up-down direction reflects vibration of the vehicle in the up-down direction when the vehicle passes through a rut, for example. The acceleration in the up-down direction is measured by, for example, an acceleration sensor attached to the vehicle. As the deterioration degree, the maintenance control index (MCI) may be used. The MCI is a composite deterioration index calculated from, for example, a crack rate, a rut amount, and flatness.

The diagnosis unit 12 may diagnose the deterioration degree for each deterioration aspect. For example, the diagnosis model detects a crack from an image and diagnoses the deterioration degree based on the width and length of the crack. The diagnosis model may detect potholes from an image and diagnose the deterioration degree based on the number, depth, and size of the potholes. The diagnosis model may detect a rut from an image and diagnose the deterioration degree based on the width and depth of the rut. The diagnosis unit 12 may diagnose the deterioration degree for each aspect of the abnormality of the road surface using the diagnosis model, and may set a total value of the deterioration degrees in each aspect as the deterioration degree of the road surface. The diagnosis unit 12 may perform weighting for each deterioration mode of the road surface, calculate the total value of the deterioration degrees in each mode based on the weighting, and set the total value as the deterioration degree of the road surface.

The generation unit 13 generates a travel route for capturing an image used for diagnosis of the deterioration degree of the road surface based on the deterioration degree of the road surface diagnosed by the diagnosis unit 12 and the road environment that affects diagnosis of the deterioration degree of the road surface for each point. The generation unit 13 generates, for example, a travel route including a point where a vehicle that captures an image used for diagnosis of the deterioration degree of the road surface travels and a timing of traveling the point.

The timing at which the vehicle travels is, for example, the time of traveling at each point, the date of traveling, the time of day of traveling, or the period of traveling. The timing of traveling may be a traveling start time or a date and time. The timing of traveling may be the time of traveling at each point, the date and time of traveling, and the time of day of traveling. The timing of traveling may be a time, a date and time, or a time of day at which the vehicle passes through a set point among points included in the travel route. The point where the timing of traveling is set is set by, for example, the road manager or the worker. The timing of traveling is not limited to the above.

For example, the generation unit 13 generates a travel route allowing the vehicle to efficiently go around the diagnosis target point while satisfying the road environment where an image suitable for diagnosis of the deterioration state of the road surface can be captured. For example, the generation unit 13 generates a travel route for capturing an image used for diagnosis of the deterioration degree of the road surface based on the deterioration degree of the road surface diagnosed by the diagnosis unit 12, the road environment that affects diagnosis of the deterioration degree of the road surface for each point, and the time required for movement between points. The generation unit 13 generates a travel route for capturing an image used for diagnosis of the deterioration degree of the road surface based on, for example, the deterioration degree of the road surface diagnosed by the diagnosis unit 12, the road environment that affects diagnosis of the deterioration degree of the road surface for each point, and the distance between points.

The generation unit 13 generates a travel route by solving an optimization problem, for example. The generation unit 13 generates the travel route by combining feature amounts under a constraint condition, for example, and obtaining a determination coefficient that maximizes or minimizes an objective function.

The objective function is, for example, travel time. The travel time is, for example, a time required for traveling on the travel route. When the objective function is the travel time, the generation unit 13 generates the travel route in such a way that the travel time required for travel in a set range is minimized. The objective function may be the number of travel points or a travel distance. In a case where the objective function is the number of travel points or the travel distance, the generation unit 13 generates the travel route in such a way that the number of travel points or the travel distance circulating within the set time is maximized. The objective function may be set using the deterioration degree. In a case where the objective function is set using the deterioration degree, the generation unit 13 generates the travel route in such a way that, for example, the average value of the deterioration degrees becomes equal to or more than a set value. The generation unit 13 may generate the travel route in such a way that, for example, the total value of the deterioration degrees becomes equal to or more than a set value. The determination coefficient is, for example, a point where the vehicle travels. The generation unit 13 generates the travel route by determining, for example, a travel point and a travel order.

The feature amount is, for example, the deterioration degree of the road surface. The feature amount may include the time required for movement between points. The feature amount may include the distance between points. The feature amount is not limited to the above.

The constraint condition is set using, for example, the road environment that affects diagnosis of the deterioration degree of the road surface for each point. For example, the constraint condition is set in such a way that the vehicle passes through at the timing of the road environment where an image suitable for diagnosis of the deterioration degree of the road surface can be captured. The constraint condition is set in such a way that, for example, the vehicle passes through at the timing of the road environment having a small influence on capturing of an image for diagnosing the deterioration degree of the road surface. That is, the constraint condition is set in such a way that the vehicle does not pass through the point of the road environment at the timing when the road environment becomes not suitable for diagnosis of the deterioration degree of the road surface, for example. The constraint condition is set as not passing through at the timing of the road environment that affects capturing of an image for diagnosing the deterioration degree of the road surface, for example. The generation unit 13 generates a travel route to avoid the vehicle traveling to a point at the timing of the road environment that affects capturing of the image for diagnosing the deterioration degree of the road surface. For example, the constraint condition is set as not passing through a point where a shadow is cast on the road surface in a time of day where the shadow is cast on the road surface, for example. Then, at the timing when a shadow is cast on the road surface, the generation unit 13 generates a travel route to avoid the vehicle traveling to a point where a shadow is cast. The constraint condition may be set based on the deterioration degree. The constraint condition based on the deterioration degree is set as passing through a point where the deterioration degree is equal to or more than the criterion, for example.

The constraint condition may be set as a point through which the vehicle always passes. For example, the constraint condition is set as always passing through a point where the road surface is possibly deteriorated due to an event being held. For example, the constraint condition is set as always passing through a point where the road surface is possibly deteriorated due to snow cover or snow melting. The constraint condition may be set as a point through which the vehicle does not pass. For example, the constraint condition is set as not passing through a point where the vehicle cannot pass due to an event being held. For example, the constraint condition is set as not passing through a point where the vehicle cannot pass due to road work. For example, the constraint condition is set as not passing through a point where repair has been performed. Alternatively, the constraint condition may designate a timing of passing or a timing of not passing. The constraint condition may be passing through a point where at least one of the deterioration degree of the road surface and a progress degree of the deterioration degree of the road surface is equal to or more than a criterion.

The generation unit 13 may generate a travel route with a constraint condition that the vehicle does not pass through a point where congestion occurs at the timing when the road is congested. The generation unit 13 generates a travel route to avoid the vehicle raveling a point where congestion occurs at the timing when the road is congested, for example. The generation unit 13 may generate the travel route based on a constraint condition regarding the season or the weather. For example, the generation unit 13 generates the travel route in such a way as to satisfy a condition based on the season or the weather. The constraint condition regarding the season or the weather is, for example, a constraint condition regarding a road environment that changes depending on the season or the weather. The constraint condition regarding the season is set as not passing through a point where there are many fallen leaves in autumn that has many fallen leaves, for example. The constraint condition is set as not passing through a point having snow cover in a snow cover area, for example. The constraint condition regarding the weather is set as not passing through a point where the road surface of the road becomes dark that is not suitable for diagnosis of the deterioration degree when it is cloudy, for example. The constraint condition is not limited to the above.

The generation unit 13 may generate a travel route on a road within the monitoring range based on the monitoring range designated on the map. The generation unit 13 may generate a travel route passing through a point with high monitoring priority based on a point with high monitoring priority designated on the map.

The generation unit 13 may generate travel routes for a plurality of times. For example, when one vehicle travels a plurality of times per day, the generation unit 13 may generate a travel route for each of the plurality of times. In a case where traveling is performed a plurality of times per day, the generation unit 13 generates a travel route based on, for example, the time of day of travel. For example, in a case where there is a point where a shadow is cast in the morning and no shadow is cast in the afternoon, the generation unit 13 generates a travel route in such a way that the vehicle travels at the point in the time of day in the afternoon in which no shadow is cast.

The generation unit 13 may generate a travel route for a set period. For example, the generation unit 13 generates a travel route in such a way that the vehicle passes through all points in the monitoring target range in one week. For example, in a case where there is a point that is congested on a specific day of the week, the generation unit 13 generates a travel route in such a way that the vehicle does not pass through the point on the congested day of the week. The setting of the period is not limited to one week.

When generating travel routes for a plurality of times, the generation unit 13 may generate the travel route in such a way that the vehicle passes through, a plurality of times, a point where the deterioration degree is equal to or more than the criterion. When generating travel routes for a plurality of times, the generation unit 13 may perform weighting each point based on the deterioration degree, and generate a travel route with a difference in the number of times of passing for each point. In a case where monitoring is performed by traveling of a plurality of vehicles, the generation unit 13 may generate a travel route for each vehicle. The generation unit 13 may generate the travel route in such a way that the number of times of passing through each point is equalized.

The generation unit 13 may generate the travel route using a route generation model. The route generation model generates the travel route based on the diagnosed deterioration degree of the road surface for each point and the road environment that affects diagnosis of the deterioration degree of the road surface for each point. The route generation model is a learning model generated by machine learning. The route generation model may generate the travel route based on the diagnosed deterioration degree of the road surface for each point, the road environment that affects diagnosis of the deterioration degree of the road surface for each point, and the time required for movement between points.

The output unit 14 outputs the generated travel route. The travel route includes, for example, the timing of traveling. The timing of traveling is, for example, the departure time, the time of day of travel, or the date and time of traveling. The timing of traveling may be a timing of passing through each point included in the travel route or each section of the road. The output unit 14 may output a point of a road environment that affects capturing together with the travel route. The output unit 14 may output, together with the travel route, information on the time of day in which a road environment that affects capturing is present.

The output unit 14 outputs the travel route to the terminal device 30, for example. The output unit 14 superimposes the generated travel route on a map, for example, and outputs the same. The output unit 14 may superimpose information regarding the timing of traveling together with the travel route on a map, and output the same. The output unit 14 may superimpose information on a point of a road environment that affects capturing or a time of day of a road environment that affects a shadow together with the travel route on a map and output the same.

The output unit 14 outputs the travel route by superimposing a mark indicating the travel direction on a map, for example. For example, the output unit 14 outputs the travel route using an arrow indicating the travel direction as a mark indicating the travel direction. The output unit 14 may output the travel route using a number indicating the travel order. The output unit 14 may superimpose and output the time required for movement between points on the map. The output unit 14 may superimpose and output the distance between points on the map. The output unit 14 may output the travel route using a list indicating the travel order for each point name or road name. The output unit 14 may further superimpose and output the deterioration degree of each point on the map. The form of output of the travel route is not limited to the above. The output unit 14 may output the travel route to a car navigation system. When the travel route is output to the car navigation system, the car navigation system guides the travel route of the vehicle using the travel route acquired from the route generation system 10, for example.

The output unit 14 may output a setting screen of the monitoring range. In a case where passing through a point where the deterioration degree is equal to or more than the criterion is a constraint condition, the output unit 14 may output an input screen of a criterion value of the deterioration degree.

The output unit 14 may output the deterioration degree for each point diagnosed by the diagnosis unit 12. The output unit 14 outputs the deterioration degree diagnosed by the diagnosis unit 12 to the terminal device 30, for example. The output unit 14 may output the deterioration degree diagnosed by the diagnosis unit 12 to the in-vehicle device 20. The output unit 14 may output the deterioration degree diagnosed by the diagnosis unit 12 to the server connected via the network.

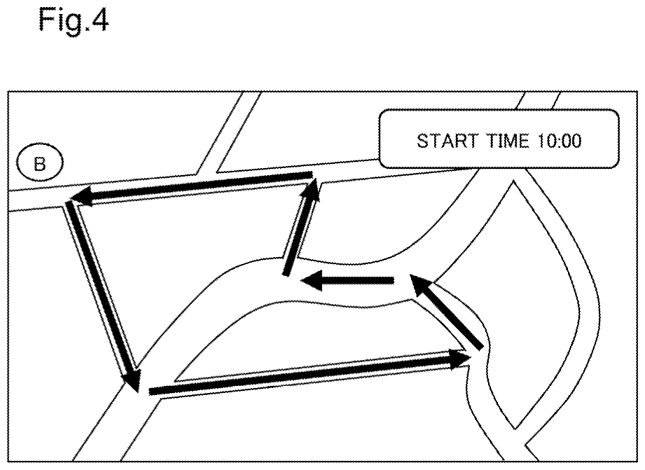

FIG. 4 is a view illustrating an example of a display screen displaying a generated travel route. In the example of the display screen of FIG. 4, the travel route is superimposed on the map and displayed. In the example of the display screen of FIG. 4, the travel order is displayed by an arrow on the map. In the example of the display screen of FIG. 4, “B” indicates a departure point and a return point of the vehicle that captures an image of the road. The departure point and the return point may be different. The vehicle going around on the road travels on the road indicated by the arrow, for example, with the point “B” as a departure point. In the example of the display screen of FIG. 4, information regarding the timing of traveling is displayed in the upper right part. In the example of the display screen of FIG. 4, the start time at which traveling is started is displayed as “start time 10:00” as the timing of traveling.

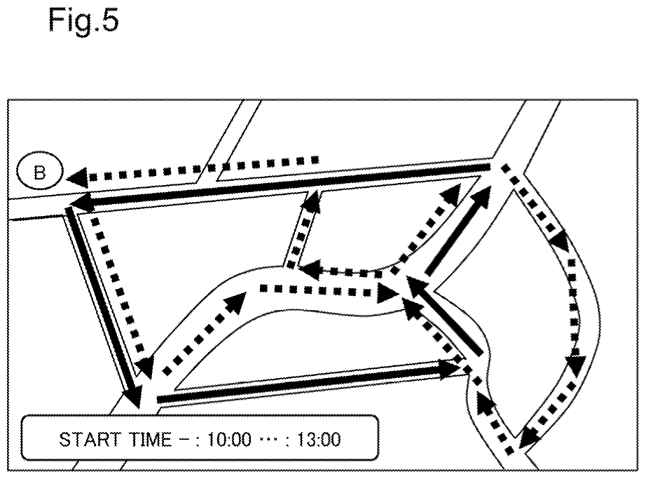

FIG. 5 is a view illustrating an example of a display screen displaying a plurality of travel routes. In the example of the display screen of FIG. 5, a plurality of travel routes are superimposed on the map and displayed. In the example of the display screen of FIG. 5, the travel order is displayed by solid and broken arrows on the map. For example, when the generation unit 13 generates travel routes for two times, the output unit 14 superimposes the travel routes for two times on the map and outputs the same. The output unit 14 may generate travel routes for three times or more. The output unit 14 may output a travel route selected by the worker among the plurality of travel routes. In the example of the display screen of FIG. 5, “B” indicates a departure point and a return point of the vehicle that captures an image of the road. The departure point and the return point may be different for each time of travel. In the example of the display screen of FIG. 5, the start time for starting traveling is displayed as “start time—:10:00 . . . :13:00” as the timing of traveling on each route. The example of the display screen of FIG. 5 indicates that traveling along the route indicated by the solid arrow is started at 10:00 and traveling along the route indicated by the broken arrow is started at 13:00. The display of the timing of traveling is not limited to the example illustrated in FIGS. 4 and 5.

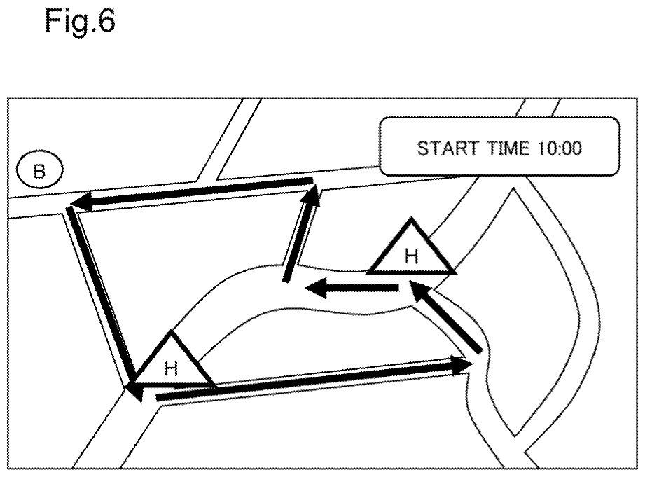

FIG. 6 is a view illustrating an example of a display screen displaying a generated travel route and a point having a high deterioration degree. In the example of the display screen of FIG. 6, a travel route and a point having a high deterioration degree are superimposed on the map and displayed. In the example of the display screen of FIG. 6, a character “H” is displayed, on the map, at a point where the deterioration degree is equal to or more than the criterion. The deterioration degree may be displayed in a plurality of stages. The deterioration degree may be displayed using a numerical value indicating the deterioration degree.

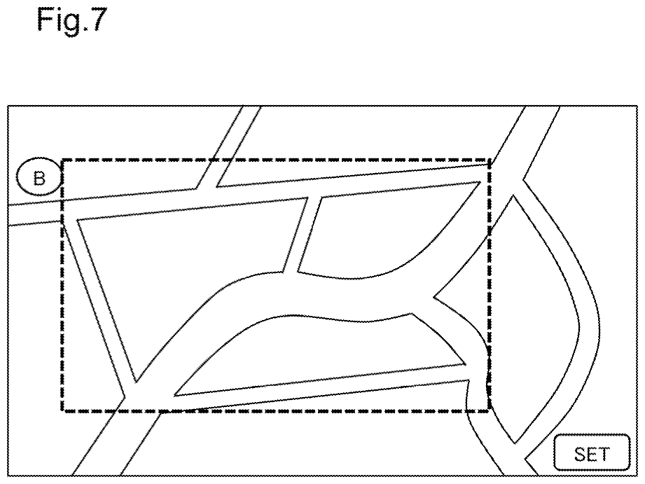

FIG. 7 is a view illustrating an example of a display screen for selecting a monitoring target range. In the example of the display screen of FIG. 7, selection of a monitoring target range is performed by selecting a range with a broken line frame on the map. The worker selects the monitoring target range by mouse operation, for example. The generation unit 13 generates, for example, a travel route on a road within the selected range. The monitoring target range may be selected by designating each point on the map.

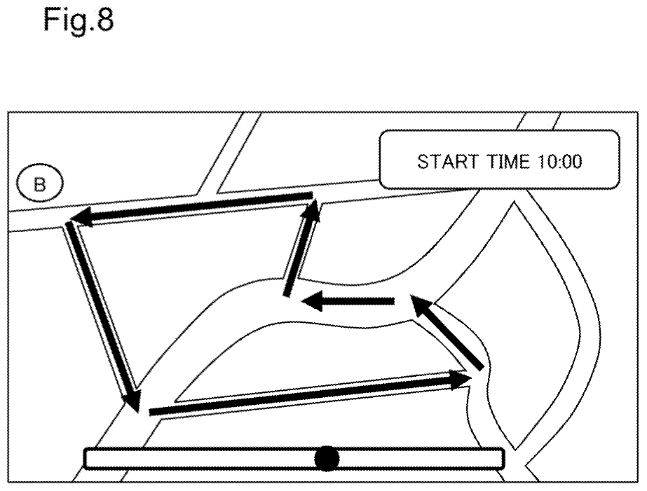

FIG. 8 is a view illustrating an example of a display screen for selecting a criterion of the deterioration degree. In the example of the display screen of FIG. 8, a slider bar for selecting the criterion of the deterioration degree is displayed at the lower part of the screen. The criterion of the deterioration degree is a criterion for designating a point through which the vehicle always passes. When the criterion of the deterioration degree is selected, the generation unit 13 generates, for example, a travel route passing through a point where the deterioration degree is equal to or more than the criterion. In the example of the display screen of FIG. 8, for example, moving the slider bar to the right raises the criterion of the deterioration degree. In the example of the display screen of FIG. 8, for example, moving the slider bar to the left lowers the criterion of the deterioration degree. When the criterion is changed by the slider bar, the output unit 14 may superimpose the travel route generated by the changed criterion on the map and output the same.

The storage unit 15 saves data used for generation of the travel route, for example. The storage unit 15 saves map data regarding the road on which the vehicle travels, for example. The storage unit 15 saves information used for generation of the travel route, for example. The information used for generation of the travel route is, for example, a road environment that affects diagnosis of the deterioration degree of the road surface for each point. The information used for generation of the travel route is an objective function, a constraint condition, and a feature amount that are used to solve an optimization problem, for example. The information used for generation of the travel route is not limited to the above. The storage unit 15 may save an image obtained by capturing the monitoring target road. The storage unit 15 may save the travel route generated by the generation unit 13.

The storage unit 15 saves a diagnosis model, for example. The storage unit 15 saves information regarding an optimization algorithm used when, for example, the generation unit 13 generates the travel route. When the generation unit 13 generates the travel route using a generation model, the storage unit 15 saves the generation model, for example. The diagnosis model, the optimization algorithm, and the generation model may be saved in a storage means other than the storage unit 15.

The in-vehicle device 20 includes the image-capturing device that captures an image of the front of the vehicle, for example. The image-capturing device of the in-vehicle device 20 captures an image including the road surface of the road. The image-capturing device of the in-vehicle device 20 may capture an image of the rear of the vehicle. For example, the in-vehicle device 20 adds, to the captured image, information on the position where the image is captured. The in-vehicle device 20 specifies the vehicle position when the image is captured using, for example, a global navigation satellite system (GNSS). The in-vehicle device 20 may specify the vehicle position based on a beacon including position information. The in-vehicle device 20 may specify the capturing point based on the travel distance from the point where the vehicle position is specified and map information. The in-vehicle device 20 outputs the captured image to the route generation system 10, for example.

The in-vehicle device 20 may include a sensor that measures the state of the vehicle. The in-vehicle device 20 includes, for example, an acceleration sensor that measures vibration in the up-down direction of the vehicle. In a case of including the sensor, the in-vehicle device 20 adds position information at the time of measurement to the measurement result by the sensor. Then, the in-vehicle device 20 outputs the measurement result by the sensor to the route generation system 10 via the network, for example. For example, a dashboard camera is used as the in-vehicle device 20. The in-vehicle device 20 is not limited to a dashboard camera.

The terminal device 30 acquires the travel route generated by the route generation system 10, for example. Then, the terminal device 30 outputs the acquired travel route to a display device not illustrated. The terminal device 30 may acquire the monitoring target range input by the operation of the worker. The terminal device 30 outputs the acquired monitoring target range to the route generation system 10, for example. The terminal device 30 may acquire the constraint condition input by the operation of the worker. The terminal device 30 outputs the acquired constraint condition to the route generation system 10, for example.

As the terminal device 30, for example, a personal computer, a tablet computer, or a smartphone can be used. The terminal device 30 is not limited to the above example. The in-vehicle device 20 and the terminal device 30 may be an integrated device.

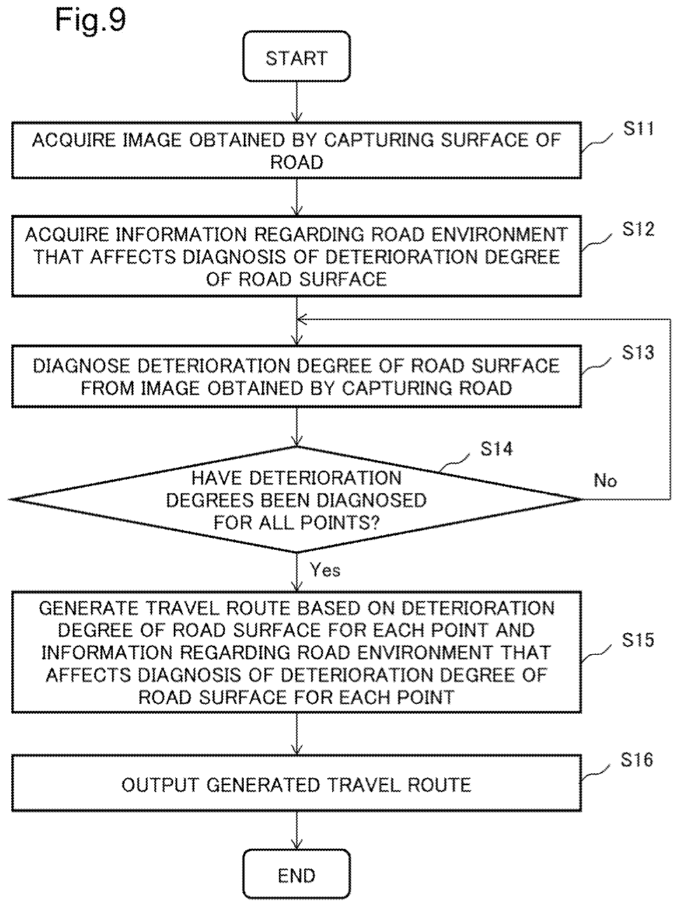

The operation of the route generation system 10 when generating the travel route of the vehicle that captures an image of the road surface of the road will be described. FIG. 9 illustrates an example of the operation flow of the route generation system 10 when generating the travel route.

The acquisition unit 11 acquires an image obtained by capturing the road surface of the monitoring target road (step S11). The acquisition unit 11 acquires information regarding the road environment that affects diagnosis of the deterioration degree of the road surface (step S12).

Upon acquiring the image obtained by capturing the road surface of the monitoring target road and the information regarding the road environment, the diagnosis unit 12 diagnoses the deterioration degree of the road surface from the image obtained by capturing the monitoring target road (step S13).

When there is a point where the diagnosis of the deterioration degree is done (No in step S14), the diagnosis unit 12 diagnoses the deterioration degree of the road surface for an image where the diagnosis of the deterioration degree is not done in step S13.

In a case where the diagnosis of the deterioration degree is done for the target point (Yes in step S14), the generation unit 13 generates the travel route for capturing an image used for diagnosis of the deterioration degree of the road surface based on the diagnosed deterioration degree of the road surface for each point and the road environment affecting diagnosis of the deterioration degree of the road surface for each point (step S15). The generation unit 13 generates the travel route by solving an optimization problem, for example, with the time required for traveling as an objective function, the deterioration degree of the road surface as a feature amount, and the road environment affecting diagnosis as a constraint condition.

When the travel route is generated, the output unit 14 outputs the generated travel route (step S16). The output unit 14 outputs the generated travel route to the terminal device 30, for example. Upon acquiring the travel route, the terminal device 30 outputs the acquired travel route to a display device not illustrated, for example.

The route generation system 10 of the present example embodiment diagnoses the deterioration degree of the road surface from the image where the road surface of the monitoring target road appears. Then, the route generation system 10 generates the travel route for monitoring the road surface based on the diagnosed deterioration degree of the road surface and the road environment that affects capturing. By generating the travel route based on the deterioration degree of the road surface and the road environment that affects the capturing, the route generation system 10 can generate the travel route that is not affected by the environment in acquiring the image while passing through a point necessary for monitoring the road surface of the road. Therefore, by traveling in accordance with the travel route generated by the route generation system 10, it is possible to efficiently acquire an image necessary for monitoring deterioration of the road surface of the road.

For example, by generating a travel route where the vehicle does not pass through at the timing of the road environment that affects capturing of an image for diagnosing the deterioration degree of the road surface, such as a timing at which a shadow is cast on the road surface, it is possible to reliably acquire an image suitable for diagnosis of the deterioration degree. For example, by generating a travel route where the vehicle does not pass through at the timing when the road is congested, it is possible to suppress the possibility that the road surface is hidden by other vehicles. As described above, by using the route generation system 10, it is possible to generate an efficient travel route of the vehicle in monitoring the road surface condition of the road. Therefore, use of the route generation system 10 makes it possible to improve efficiency of monitoring of the road surface condition of the road performed by traveling of the vehicle.

When generating travel routes for a plurality of times within a set period, the route generation system 10 can generate a more efficient travel route by generating the travel route based on the date and time of travel and the road environment that affects diagnosis of the deterioration degree of the road surface for each point.

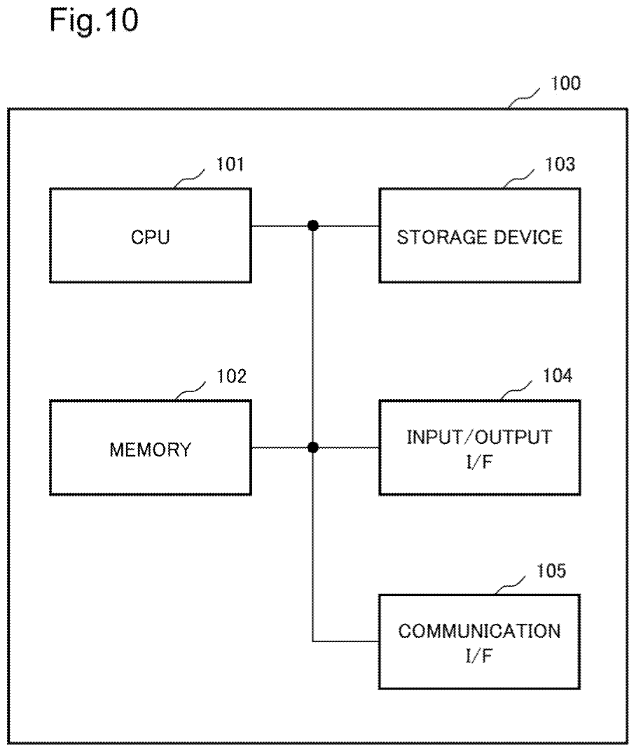

Each processing in the route generation system 10 can be implemented by a computer executing a computer program. FIG. 10 illustrates an example of the configuration of a computer 100 that executes a computer program for performing each processing in the route generation system 10. The computer 100 includes a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM), and temporarily stores a computer program to be executed by the CPU 101 and data being processed. The storage device 103 stores a computer program to be executed by the CPU 101. The storage device 103 includes, for example, a nonvolatile semiconductor storage device. As the storage device 103, another storage device such as a hard disk drive may be used. The input/output I/F 104 is an interface that receives input from the worker and outputs display data and the like. The communication I/F 105 is an interface that transmits and receives data to and from the in-vehicle device 20, the terminal device 30, and other information processing devices. The terminal device 30 may have a configuration similar to that of the computer 100.

The computer program used for executing each processing can also be distributed by being stored in a computer-readable recording medium that non-transitorily records data. As the recording medium, for example, a data recording magnetic tape or a magnetic disk such as a hard disk can be used. As the recording medium, an optical disk such as a compact disc read only memory (CD-ROM) can also be used. A nonvolatile semiconductor storage device may be used as the recording medium.

A part or the entirety of the above example embodiment can be described as Supplementary Notes below, but are not limited to the following.

### [Supplementary Note 1]

A route generation system including:
a diagnosis unit configured to diagnose a deterioration degree of a road surface from an image obtained by capturing a monitoring target road;
a generation unit configured to generate a travel route for capturing an image used for diagnosis of a deterioration degree of a road surface based on the deterioration degree of the road surface for each point diagnosed by the diagnosis unit and a road environment affecting diagnosis of the deterioration degree of the road surface for each point; and
an output unit configured to output the generated travel route.

### [Supplementary Note 2]

The route generation system according to Supplementary Note 1, in which
the generation unit generates a travel route including a point where a vehicle that captures the image used for diagnosis of the deterioration degree of the road surface travels and a timing at which the vehicle travels at the point.

### [Supplementary Note 3]

The route generation system according to Supplementary Note 2, in which
the travel route avoids the vehicle traveling to a point where a road environment is not suitable for diagnosis of the deterioration degree of the road surface at a timing when the vehicle passes the point.

### [Supplementary Note 4]

The route generation system according to Supplementary Note 3, in which
the travel route avoids the vehicle traveling to a point where a shadow is cast on the road surface at a timing when the vehicle passes the point.

### [Supplementary Note 5]

The route generation system according to Supplementary Note 3, in which
the travel route avoids the vehicle traveling to a point a point where congestion of the road occurs at a timing when the vehicle passes the point.

### [Supplementary Note 6]

The route generation system according to Supplementary Note 3, in which
the travel route satisfies a condition based on a season or weather.

### [Supplementary Note 7]

The route generation system according to any of Supplementary Notes 1 to 6, in which
the generation unit generates a travel route that includes a point where at least one of a deterioration degree of a road surface and a progress degree of a deterioration degree of a road surface is equal to or more than a criterion.

### [Supplementary Note 8]

The route generation system according to any of Supplementary Notes 1 to 6, in which
the generation unit generates the travel route based on a time required for traveling in a set range.

### [Supplementary Note 9]

The route generation system according to any of Supplementary Notes 1 to 6, in which
the generation unit generates the travel route based on a number of points where a vehicle goes around in time.

### [Supplementary Note 10]

The route generation system according to any of Supplementary Notes 1 to 6, in which
the generation unit generates a travel route of a vehicle mounted with a dashboard camera that captures the image used for diagnosis of the deterioration degree of the road surface.

### [Supplementary Note 11]

The route generation system according to any of Supplementary Notes 1 to 6 further including:
an acquisition unit configured to acquire a monitoring range designated on a map, in which
the generation unit generates the travel route on a road within the monitoring range.

### [Supplementary Note 12]

The route generation system according to any of Supplementary Notes 1 to 6, in which
the route generation system acquires a point where priority of monitoring designated on a map is high, and
the generation unit generates the travel route that passes through the point where the priority of monitoring is high.

### [Supplementary Note 13]

A route generation method including:
diagnosing a deterioration degree of a road surface from an image obtained by capturing a monitoring target road;
generating a travel route for capturing an image used for diagnosis of a deterioration degree of a road surface based on the deterioration degree of the road surface for each point diagnosed by the diagnosis unit and a road environment affecting diagnosis of the deterioration degree of the road surface for each point; and
outputting the generated travel route.

### [Supplementary Note 14]

A non-transitory computer readable recording medium recording a route generation program to cause a computer to execute
processing of diagnosing a deterioration degree of a road surface from an image obtained by capturing a monitoring target road,
processing of generating a travel route for capturing an image used for diagnosis of a deterioration degree of a road surface based on the deterioration degree of the road surface for each point diagnosed by the diagnosis unit and a road environment affecting diagnosis of the deterioration degree of the road surface for each point, and
processing of outputting the generated travel route.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A route generation system comprising:
at least one memory storing instructions; and
at least one processor configured to access the at least one memory and execute the instructions to:
perform a diagnosis to estimate a deterioration degree of a road surface from an image of a road to be monitored;
generate a travel route based on the diagnosed deterioration degree of the road surface for each point and a road environment affecting the diagnosis for each point, the travel route being generated for capturing another image used for another diagnosis; and
output the generated travel route.

2. The route generation system according to claim 1, wherein
the at least one processor is further configured to execute the instructions to:
generate the travel route including a point and a timing at which the vehicle that captures the another image used for the another diagnosis travels at the point.

3. The route generation system according to claim 2, wherein
the at least one processor is further configured to execute the instructions to:
generate the travel route to avoid the vehicle traveling to a point at a timing at which the road environment is determined to not be suitable for the another diagnosis.

4. The route generation system according to claim 3, wherein
the at least one processor is further configured to execute the instructions to:
generate the travel route to avoid the vehicle traveling to a point where a shadow is cast on the road surface at a timing when the vehicle passes the point.

5. The route generation system according to claim 3, wherein
the at least one processor is further configured to execute the instructions to: generate the travel route to avoid the vehicle traveling to a point where congestion of the road occurs at a timing when the vehicle passes the point.

6. The route generation system according to claim 3, wherein
the travel route satisfies a condition based on a season or weather.

7. The route generation system according to claim 1, wherein
the at least one processor is further configured to execute the instructions to:
generate the travel route including a point where at least one of a deterioration degree of a road surface and a progress degree of a deterioration degree of a road surface is equal to or more than a criterion.

8. The route generation system according to claim 1, wherein
the at least one processor is further configured to execute the instructions to:
generate the travel route based on a time required for traveling in a set range.

9. The route generation system according to claim 1, wherein
the at least one processor is further configured to execute the instructions to:
generate the travel route based on a number of points where a vehicle goes around in time.

10. The route generation system according to claim 1, wherein
the at least one processor is further configured to execute the instructions to:
generate the travel route of a vehicle mounted with a dashboard camera that captures the another image used for the another diagnosis.

11. The route generation system according to claim 1, wherein
the at least one processor is further configured to execute the instructions to:
acquire a monitoring range designated on a map; and
generate the travel route on a road within the monitoring range.

12. The route generation system according to claim 1, wherein
the at least one processor is further configured to execute the instructions to:
acquire a point where priority of monitoring designated on a map is high; and
generates the travel route that includes the point where the priority of monitoring is high.

13. The route generation system according to claim 1, wherein
the at least one processor is further configured to execute the instructions to:
perform the another diagnosis to estimate the deterioration degree of the road surface from the another image.

14. A route generation method comprising:
performing a diagnosis to estimate a deterioration degree of a road surface from an image of a road to be monitored;
generating a travel route based on the deterioration degree of the road surface for each point diagnosed by the diagnosis means and a road environment affecting the diagnosis for each point, the travel route being generated for capturing another image used for another diagnosis; and
outputting a generated travel route.

15. A non-transitory computer readable recording medium recording a route generation program to cause a computer to execute
processing of performing a diagnosis to estimate a deterioration degree of a road surface from an image of a road to be monitored,
processing of generating a travel route based on the deterioration degree of the road surface for each point diagnosed by the diagnosis means and a road environment affecting the diagnosis for each point, the travel route being generated for capturing another image used for another diagnosis, and
processing of outputting a generated travel route.
